(19) United States
(12) Patent Application Publication
(10) Pub. No.: US 2021/0405749 A1
(43) Pub. Date: Dec. 30, 2021

(54) ASSEMBLY-TYPE MOUSE

(71) Applicants: MING HSUAN CHUNG, TAOYUAN CITY (TW); E NAME CO., LTD., Taipei City (TW)

(72) Inventor: MING HSUAN CHUNG, TAOYUAN CITY (TW)

(21) Appl. No.: 17/337,724

(22) Filed: Jun. 3, 2021

(30) Foreign Application Priority Data
Jun. 30, 2020 (TW) 109122140

(51) Int. Cl. G06F 3/01; G06F 3/0354

(52) U.S. Cl. CPC G06F 3/014; G06F 3/03544

(57) ABSTRACT

An assembly-type mouse comprises a dismountable casing, a processor, at least one press key and at least one track sensor. The dismountable casing includes an upper casing and a lower casing. The upper casing includes a body and at least two moveable sidewalls. Two moveable sidewalls are respectively disposed at two sides of the body and able to rotate with respect to the body. The processor and press keys are disposed inside the dismountable casing. The press key has a press member on the surface thereof and a first connector configured to connect with a press-key input port of the processor. The track sensor has a second connector configured to connect with a track-sensor input port of the processor. The mouse may be disassembled. Reassembling the mouse can generate different application forms of the mouse.

This application claims priority of Application No. 109122140 filed in Taiwan on 30 Jun. 2020 under 35 U.S.C. § 119; the entire contents of all of which are hereby incorporated by reference.

### BACKGROUND OF THE INVENTION

### Field of the Invention

The present invention relates to a digital data-processing technology, particularly to an assembly-type mouse.

### Description of the Prior Art

The mouse is an ordinary input device of computers. The mouse controls the cursor on the screen to facilitate operations of a computer. The traditional mouse is unlikely to be disassembled. The traditional mouse has a hand-held body. A track detection device is arranged on the bottom of the hand-held body to detect the motion track of the mouse. At least one input press key is arranged on the surface of the hand-held body and used to perform selection or other functions.

Persistent usage of a mouse may cause compression of the wrist, or even induce the carpal tunnel syndrome. The carpal tunnel syndrome is a common occupational disease of the people using the keyboard or mouse persistently. The main symptoms are pain, numbness and tingling in the thumb, index finger, middle finger and the thumb side of the ring finger.

In order to solve the above-mentioned problem, many input devices have been developed to replace the traditional mice and reduce the probability of the carpal tunnel syndrome. The new input devices include smart gloves. The smart glove is worn on the hand by the user like an ordinary glove. The smart glove controls the cursor according to the variation of the pressure generated by the hand or the variation of the frequency of the motion of the hand. A lot of time and manpower is required to develop a smart glove, including the sensing systems thereof. Further, a smart glove needs a powerful processor to analyze the pressure, depth, motions, etc. Thus, the fabrication cost of smart gloves is too high to popularize smart gloves.

Accordingly, the present invention proposes an assembly-type mouse to overcome the above-mentioned problems.

### SUMMARY OF THE INVENTION

One objective of the present invention is to provide an assembly-type mouse whose configuration can be arbitrarily changed to meet requirement, whereby the user of the present invention needn't adapt his wrist to rest on a plane persistently during usage, wherefore the compression to the hand is decreased, the hand health of the user is promoted, and the probability of the carpal tunnel syndrome is reduced.

Another objective of the present invention is to provide an assembly-type mouse whose press keys and track sensors are respectively connected to different and independent connection ports of the processor, whereby while a component is damaged, the repairman needn't replace the whole module or system but can repair or replace the damaged component easily.

In order to achieve the above-mentioned at least one objectives, the present invention provides an assembly-type mouse, which comprises a dismountable casing. The dismountable casing includes an upper casing and a lower casing. The upper casing further includes a body and at least two moveable sidewalls. The moveable sidewalls are respectively arranged on two sides of the body and mobile with respectively to the body. The dismountable casing has a processor thereinside. The pressor has at least one press-key input port and at least one track-sensor input port. A first connector is disposed on the press key and configured to connect with the press-key input port of the pressor. A second connector is disposed on the track sensor and configured to connect with the track-sensor input port.

In one embodiment, the press key is disposed inside the dismountable casing; the press key has a press member on the surface thereof; the press member protrudes from the dismountable casing.

In one embodiment, the track sensor is disposed outside the dismountable casing; the track sensor has a second connector penetrates into the dismountable casing to connect with the track-sensor input port of the processor.

In one embodiment, the second connector of the track sensor is an L-type connector.

In one embodiment, the first connector and the second connector of the track sensor are long-cable connectors.

In one embodiment, the press key has a press member on one surface thereof and a first binding strap on another surface opposite to the press member.

In one embodiment, the track sensor has a track sensing member on one surface thereof and a second binding strap on another surface opposite to the track sensing member.

In one embodiment, the processor further includes a connection port configured to connect with an external device; the orientation of the opening of the connection port is different from the orientation of the opening of the press-key input port and the orientation of the opening of the track-sensor input port.

In one embodiment, the moveable sidewall is disposed in the casing via a rotation axis.

In one embodiment, the lower casing further includes a third binding strap.

In one embodiment, the press key further includes a first finger sleeve; the first finger sleeve has a press member and a first grip member; the press member is disposed on the surface of the first finger sleeve; the first grip member is disposed on the press member and at two sides of the first finger sleeve.

In one embodiment, the track sensor further includes a second finger sleeve; the second finger sleeve has a track sensing member and a second grip member; the track sensing member is disposed on the surface of the second finger sleeve; the second grip member is disposed above the track sensing member and at two sides of the second finger sleeve.

In one embodiment, the upper casing of the dismountable casing has a first extension member; the first extension member is disposed at the front end of the body; the lower casing further has a second extension member at the front end thereof.

Below, embodiments are described in detail to make easily understood the objectives, technical contents, characteristics and accomplishments of the present invention.

### BRIEF DESCRIPTION OF THE DRAWINGS

FIG. 1 is an exploded view schematically showing an assembly-type mouse according to one embodiment of the present invention.

FIG. 2 is an exploded view schematically showing a dismountable casing according to one embodiment of the present invention.

FIG. 3 is a diagram schematically showing a first application case according to a first embodiment of the present invention.

FIG. 4 is a diagram schematically showing a second application case according to a second embodiment of the present invention.

FIG. 5 is a diagram schematically showing a third application case according to a third embodiment of the present invention.

FIG. 6 is a diagram schematically showing an alternative form of the press key according to another embodiment of the present invention.

FIG. 7 is a diagram schematically showing an alternative form of the track sensor according to another embodiment of the present invention.

### DETAILED DESCRIPTION OF THE INVENTION

The assembly-type mouse of the present invention may be arbitrarily assembled to have different forms according to requirement of the user. The present invention can exempt the hand of the user from compression caused by persistently adapting the hand to rest on a plane and reduce the probability of the carpal tunnel syndrome.

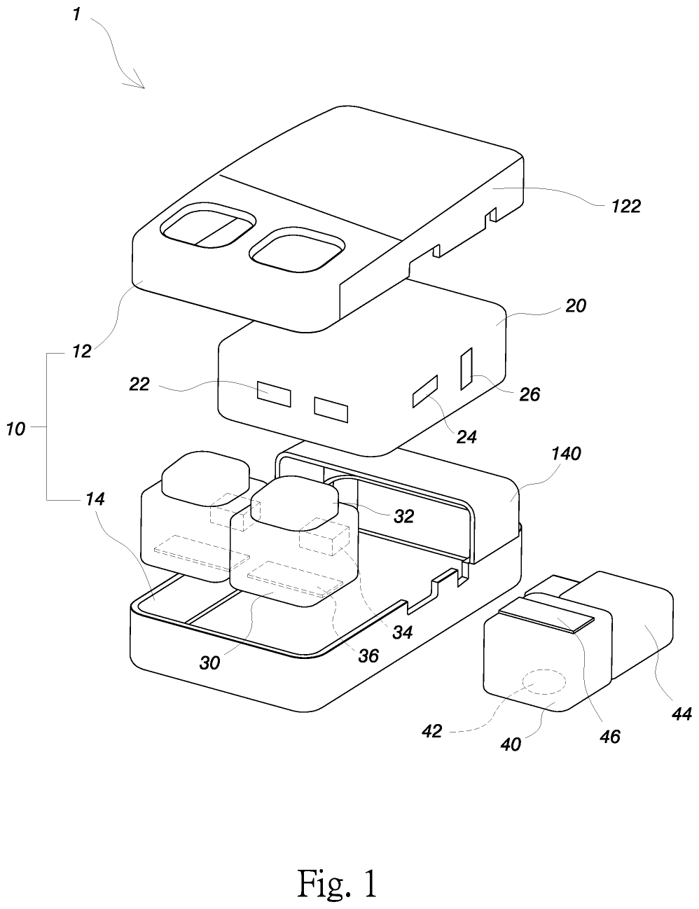

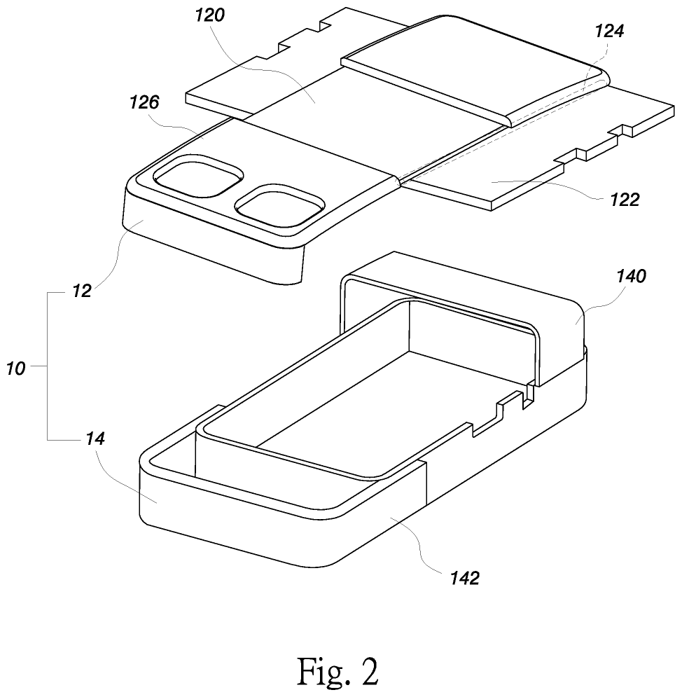

Refer to FIG. 1 and FIG. 2. The structure of the present invention will be described thereinafter to enable the readers to further understand the efficacies of the present invention. The assembly-type mouse 1 of the present invention comprises a dismountable casing 10, a processor 20, at least one press key 30, and at least one track sensor 40. Refer to FIG. 2. The dismountable casing 10 includes an upper casing 12 and a lower casing 14. The upper casing 12 further includes a body 120 and at least two moveable sidewalls 122. The moveable sidewalls 122 are opaque. The moveable sidewalls 122 are respectively disposed at two sides of the body 120 via rotation axes 124. Two moveable sidewalls 122 may be rotated with respect to the body 120. The rotation axes 124 may have snap-fit mechanisms, whereby the moveable sidewall 122 may be fixed to a position where the moveable sidewall 122 is parallel to the body 120 or a position where the moveable sidewall 122 is vertical to the body 120. The upper casing 12 further includes a first extension member 126. The first extension member 126 is disposed at the front end of the body 120 to increase the length of the upper casing 12. The lower casing 14 has a third binding strap 140. The lower casing 14 has a second extension member 142 at the front end thereof.

Refer to FIG. 1 again. The processor 20 is disposed inside the dismountable casing 10. The processor 20 includes at least one press-key input port 22, at least one track-sensor input port 24, and at least one connection port 26. In this embodiment, the processor 20 has two press-key input port 22 configured to connect with the press key 30 and one track-sensor input port 24 configured to connect with the track sensor 40. The connection port 26 is configured to connect with an external device (not shown in the drawings), such as a host computer. The processor 20 may transmit sensation signals to a host computer. Besides, the external device may transmit electric energy to the processor 20 by the connection port 26, whereby the assembly-type mouse 1 can operate using the electric energy. Further, the orientation of the opening of the connection port 26 is different from the orientation of the opening of the press-key input port 22 and the orientation of the opening of the track-sensor input port 24, whereby the user can easily recognize the signal ports of different functions.

In this embodiment, the assembly-type mouse 1 of the present invention comprises two press keys 30. Each press key 30 has a first connector 34, such as a universal serial bus (USB) or Lightning connector of Apple Inc. The first connector 34 is configured to connect with the press-key input port 22 of the processor 20. The press key 30 has a press member 32 on one surface thereof. The press key 30 further has a first binding strap 36 on another surface opposite to the surface where the press member 32 is disposed.

In this embodiment, the track sensor 40 may be an optical track sensor. The track sensor 40 has a second connector 44. The second connector 44 is configured to connect with the track-sensor input port 24 of the processor 20. The second connector 44 may be a universal serial bus (USB) or Lightning connector of Apple Inc. The second connector 44 of the track sensor 40 is an L-type connector. The track sensor 40 further includes a track sensing member 42 on one surface thereof. The track sensor 40 further includes a second binding strap 46 on another surface opposite to the surface where the track sensing member 42 is disposed.

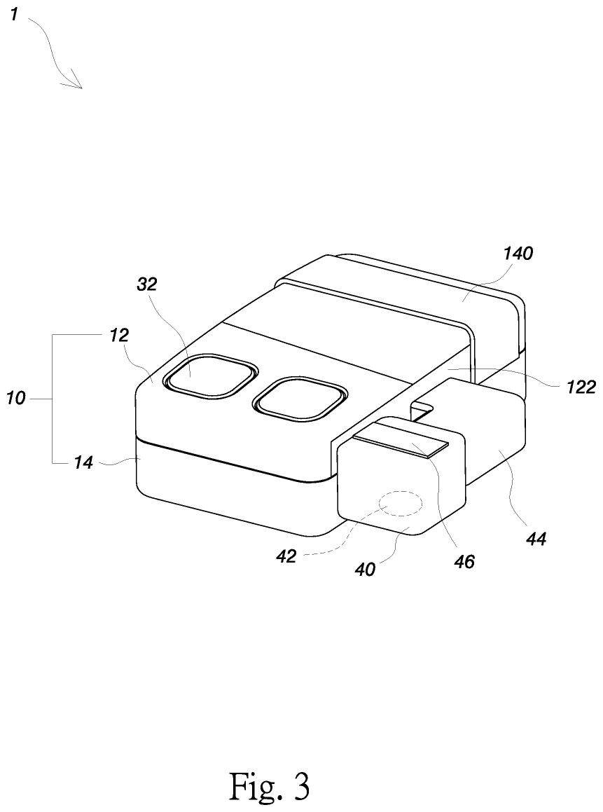

The structure of the present invention has been described above. Three embodiments of the present invention will be described below. Firstly, a first embodiment of the present invention, which is used in a first application case of the present invention, is described. Refer to FIGS. 1-3. In this embodiment, the processor 20 and two press keys 30 are encased by the dismountable casing 10. The first connectors 34 of two press keys 30 are connected with the processor 20 and encased by the dismountable casing 10 together with the processor 20. However, the press members 32 of the press keys 30 protrude out of the upper casing 12 of the dismountable casing 10. The track sensor 40 is disposed outside the dismountable casing 10; the second connector 44 of the track sensor 40 penetrates the dismountable casing 10 to connect with the track-sensor input port 24 of the processor 20. In this embodiment, the assembly is suitable to right-handed users. While a left-handed user intends to use the dismountable casing 10, the processor 20 disposed inside the dismountable casing 10 is flipped over to put the track-sensor input port 24 on the other side to favor the left-handed user. In order to make the assembly of the upper casing 12 and the lower casing 14 more secure, the third binding strap 140 of the lower casing 14 encircles the upper casing 12 to enhance the security of the assembly of the upper casing 12 and the lower casing 14.

Refer to FIG. 2. As the upper casing 12 and the lower casing 14 respectively have the first extension member 126 and the second extension member 142, the dismountable casing 10 can be adjusted to adapt to the size of the palm while the first embodiment is practiced. In other words, the first extension member 126 of the upper casing 12 and the second extension member 142 of the lower casing 14 may be adjusted to vary the length of the dismountable casing 10 and modify the size of the assembly-type mouse 1.

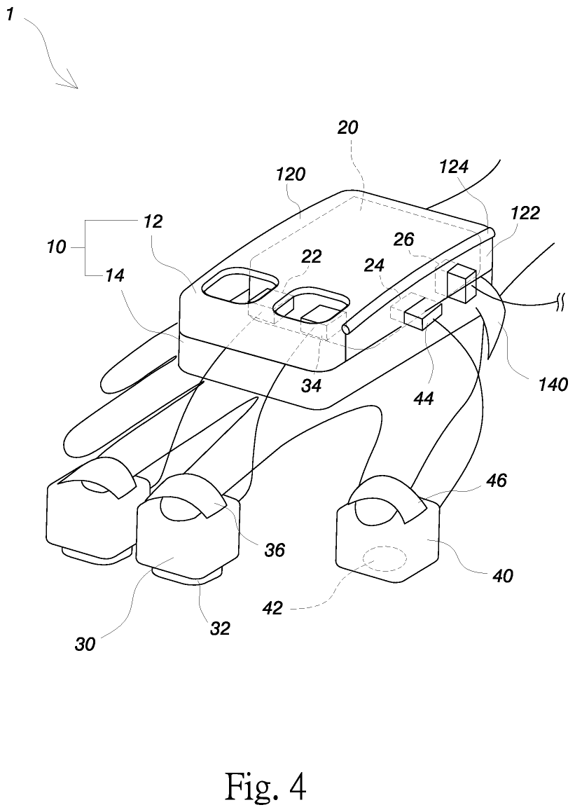

In addition to the above-mentioned embodiment, the present invention further provides a second embodiment, which is used in a second application case. In the second application case, the mouse is used in a disassembled state. Refer to FIG. 4. In the second embodiment, the dismountable casing 10 is opened; two press keys 30 and the track sensor 40 are dismounted from the processor 40; the first connectors 34 of the press keys 30 and the second connector 44 of the track sensor 40 are replaced by long-cable connectors; the fingers of the user are sleeved by the first binding straps 36 of the press keys 30 and the second binding strap 46 of the track sensor 40, wherein the index finger and the ring finger are sleeved by the first binding straps 36 of the press keys 30, and the thumb finger is sleeved the second binding strap 46 of the track sensor 40, whereby press keys 30 are mounted on the index finger and the ring finger, and the track sensor 40 is mounted on the thumb finger. Thus, the user may slide his thumb finger to make the track sensor 40 generate a sliding track. The lower body 14 is mounted on back of the hand via using third binding strap 140 to sleeve the wrist of the user. Thus, the upper casing 12, the lower casing 14 and the processor 20 are jointly carried by the back of the hand of the user. In the second application case, the press keys 30 and the track sensor 40 are operated by fingers. Therefore, the second embodiment can exempt the wrist from persistently compressing the table and reduce the probability of the carpal tunnel syndrome.

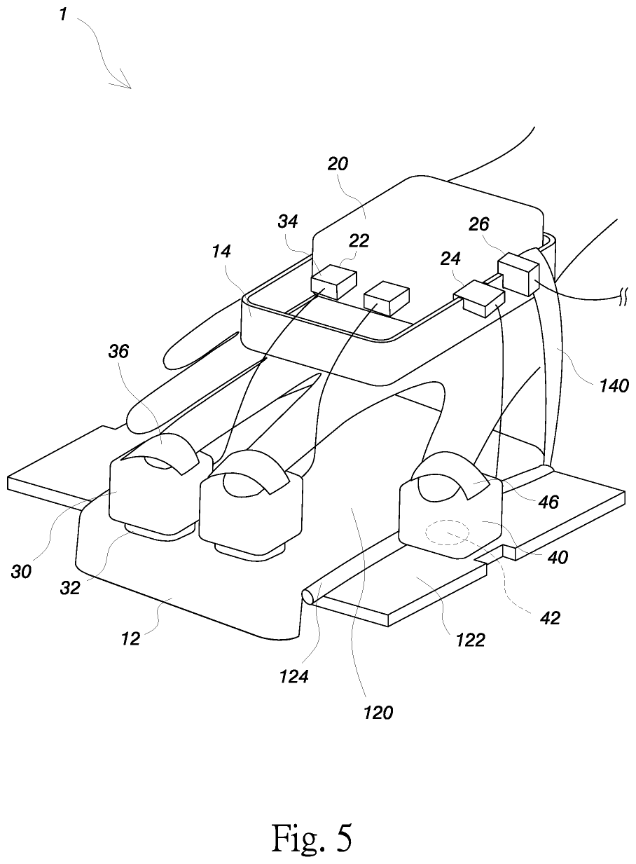

Refer to FIG. 5 for a third embodiment of the present invention, which is used in a third application case. In the third embodiment, the assembly-type mouse 1 is not operated on a tabletop. However, the press member 32 of the press key 30 must be pressed on a contact surface to generate signals; the track sensor 40 must contact a plane to sense the sliding track. In order to let the assembly-type mouse 1 work in the scenario that the press keys 30 and the track sensor 40 do not contact a tabletop, the upper casing 12 is dismounted to function as the contact surface of the press keys 30 and the track sensor 40. In the third embodiment, the moveable sidewalls 122 of the upper casing 12 are rotated upward to make the moveable sidewalls 122 parallel to the body 120. The positions and installations of the lower casing 14, the processor 20 and the track sensor 40 are the same as these of the second embodiment and will not repeat herein. In the third embodiment, the third binding strap 140 not only fixes the lower case 14 to the wrist of the user but also extends downward to fix the upper casing 12 to the wrist of the user.

In the third embodiment, the special design of the upper casing 12 makes the press keys 30 and the track sensor 40 able to generate signals to an external device although the press keys 30 and the track sensor 40 do not operate on a tabletop. Therefore, the third embodiment can exempt the wrist from persistently compressing the table and reduce the probability of the carpal tunnel syndrome.

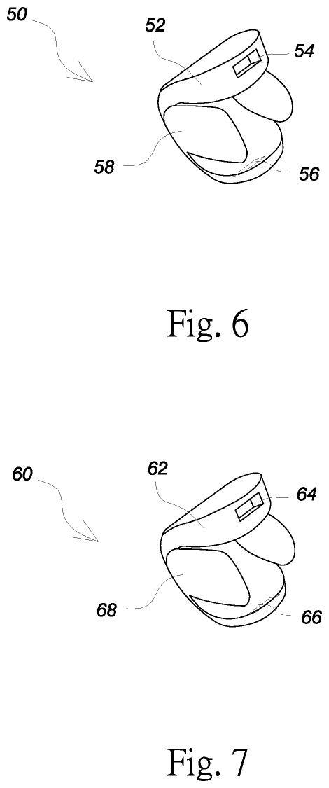

The present invention further provides another embodiment of the press keys and the track sensor for the second application and the third application. Refer to FIG. 6. In this embodiment, the press key 50 includes a finger sleeve 52. The finger sleeve 52 has a first connector 54, a press member 56, and a first grip member 58. The first connector 54 configured to connect with the at least one press-key input port 22 of the processor 20. The press member 56 is disposed on the bottom surface of the first finger sleeve 52. The first grip member 58 is disposed above the press member 56 and at two sides of the first finger sleeve 52. The user may insert his finger into the first finger sleeve 52, and the gripping force of the first grip member 58 will fix the press key 50 to the finger.

Next is described the structure of the track sensor 60 of this embodiment. Refer to FIG. 7. The track sensor 60 includes a second finger sleeve 62. The second finger sleeve 62 has a second connector 64, a track sensing member 66, and a second grip member 68. The second connector 64 configured to connect with the at least one track-sensor input port 24 of the processor 20. The track sensing member 66 is disposed on the bottom surface of the second finger sleeve 62. The second grip member 68 is disposed above the track sensing member 66 and at two sides of the second finger sleeve 62. The user may insert his finger into the second finger sleeve 62, and the gripping force of the second grip member 68 will fix the track sensor 60 to the finger.

Only the structures of the press key 50 and the track sensor 60 of this embodiment are different from that of the second embodiment and the third embodiment. The positions and installations of the dismountable casing and the processor are the same as these of the second embodiment and the third embodiment and will not repeat herein.

In conclusion, the present invention proposes an assembly-type mouse, wherein the configuration thereof may be varied according to requirement, whereby while the user persistently uses the mouse, he needn't adapt his wrist to rest on a plane, wherefore the compression to the wrist is effectively reduced, and the probability of the carpal tunnel syndrome is decreased. Further, the press keys and track sensor are respectively connected to different and independent connection ports of the processor. While a component is damaged, the repairman needn't replace the whole module or system but can repair or replace the damaged component easily.

The embodiments described above are only to exemplify the present invention but not to limit the scope of the present invention. Any equivalent modification or variation according to the characteristic or spirit of the present invention is to be also included by the scope of the present invention.

What is claimed is:

1. An assembly-type mouse, comprising
a dismountable casing, including an upper casing and a lower casing, wherein the upper casing includes a body and at least two moveable sidewalls; the two moveable sidewalls are respectively disposed at two sides of the body; the two moveable sidewalls can move with respect to the body;
a processor, disposed inside the dismountable casing, wherein at least one press-key input port and at least one track-sensor input port are disposed in the processor;
at least one press key, having a first connector configured to connect with the at least one press-key input port of the processor; and
a track sensor, having a second connector configured to connect with the track-sensor input port of the processor.

2. The assembly-type mouse according to claim 1, wherein the press key is disposed inside the dismountable casing; the press key has a press member on a surface thereof; the press member protrudes from the dismountable casing.

3. The assembly-type mouse according to claim 1, wherein the track sensor is disposed outside the dismountable casing; the second connector of the track sensor is inserted into the dismountable casing and configured to connect with the track-sensor input port of the processor.

4. The assembly-type mouse according to claim 3, wherein the track sensor is disposed on a lateral side of the dismountable casing.

5. The assembly-type mouse according to claim 1, wherein the second connector of the track sensor is an L-type connector.

6. The assembly-type mouse according to claim 1, wherein the first connector and the second connector are long-cable connector.

7. The assembly-type mouse according to claim 1, wherein a press member is disposed on a surface of the press key; a first binding strap is disposed on another surface of the press key, which is opposite to the surface where the press member is disposed.

8. The assembly-type mouse according to claim 1, wherein the track sensor includes a track sensing member disposed on a surface of the track sensor; a second binding strap is disposed on another surface of the track sensor, which is opposite to the surface where the track sensing member is disposed.

9. The assembly-type mouse according to claim 1, wherein a connection port is disposed in the processor and configured to connect with an external device; an orientation of an opening of the connection port is different from an orientation of an opening of the press-key input port and an orientation of an opening of the track-sensor input port.

10. The assembly-type mouse according to claim 1, wherein the moveable sidewall is disposed in the upper casing through a rotation axis.

11. The assembly-type mouse according to claim 1, wherein a third binding strap is disposed on the lower casing.

12. The assembly-type mouse according to claim 1, wherein the track sensor is an optical track sensor.

13. The assembly-type mouse according to claim 1, wherein the moveable sidewalls are opaque moveable sidewalls.

14. The assembly-type mouse according to claim 1, wherein the press key further includes a first finger sleeve; the first finger sleeve has a press member and a first grip member; the press member is disposed on a surface of the first finger sleeve; the first grip member disposed above the press member and at two sides of the first finger sleeve.

15. The assembly-type mouse according to claim 1, wherein the track sensor further includes a second finger sleeve; the second finger sleeve has a track sensing member and a second grip; the track sensing member is disposed on a surface of the second finger sleeve; the second grip member is disposed above the track sensing member and at two sides of the second finger sleeve.

16. The assembly-type mouse according to claim 1, wherein the upper casing of the dismountable casing further includes a first extension member disposed at a front end of the body; the lower casing of the dismountable casing further includes a second extension member disposed at a front end of the lower casing.
